(19) United States
(12) Patent Application Publication
(10) Pub. No.: US 2009/0266806 A1
(43) Pub. Date: Oct. 29, 2009

(54) MEMORY-LIKE HEAT SOURCE DEVICE

(75) Inventors: Chien-An Chen, Taipei (TW); Yuan-Sen Tsai, Taipei (TW); Min-Lang Chen, Taipei (TW)

Correspondence Address: STEVENS & SHOWALTER LLP, 7019 CORPORATE WAY, DAYTON, OH, 45459-4238, US

(73) Assignee: INVENTEC CORPORATION, Taipei (TW)

(21) Appl. No.: 12/143,947

(22) Filed: Jun. 23, 2008

(30) Foreign Application Priority Data
Apr. 23, 2008 (TW) 097206971

(51) Int. Cl. H05B 1/00

(52) U.S. Cl. 219/209

(57) ABSTRACT

A memory-like heat source device includes a substrate, a conductive layer disposed on the substrate, and at least one simulative heat source region. The simulative heat source region has at least one passive element and a simulative package. The passive element is disposed on the conductive layer and electrically connected to the conductive layer. Once being powered on, the passive element generates thermal energy and is covered by the simulative package. Therefore, a structure extremely similar to a thermal state in a practical memory is constituted.

### CROSS-REFERENCE TO RELATED APPLICATIONS

This non-provisional application claims priority under 35 U.S.C. §119(a) on Patent Application No(s). 097206971 filed in Taiwan, R.O.C. on Apr. 23, 2008 the entire contents of which are hereby incorporated by reference.

### BACKGROUND OF THE INVENTION

1. Field of the Invention

The present invention relates to a heat source device, and more particularly to a heat source device, suitable for simulating a practical memory.

2. Related Art

As the information technology industry has been vigorously developed and the information media applications have been increasingly popularized, various information products abundantly appear in the daily life, and the data processing capability of the information products is also significantly enhanced, in which a memory plays a crucial role. The memory is mainly divided into two types according to the function: one is a random access memory (RAM) emphasizing high-speed access function, and the other is a non-volatile read only memory (ROM) emphasizing the permanent memory function.

The RAM in the computer is used to register the data and quicken the operation speed of the computer. When the user uses the computer for a long time or uses the computer to execute a lot of programs, the memory has an increasingly high temperature accordingly. Therefore, the thermal dissipation function of the memory is quite important for the operation efficiency of the computer.

Currently, most computer assembly manufacturers dispose conventional resistors or transistors on a substrate and electrically connect those elements together through wires, so as to simulate the thermal state of a memory, thereby designing a preferred assembly position and a thermal dissipation manner for the memory. However, such simulative memory is different from the practical memory in terms of structure, and as a result, it cannot truly reflect the thermal conduction and flow-resistance state of the memory. Due to the elements configured on the structure, the structure usually cannot be inserted into the memory slot, or the elements are mutually squeezed together, even if the structure is inserted into the slot. As a result, the above manner cannot truly simulate the thermal conduction and flow resistance state of the memory effectively.

Furthermore, there are various memories in different specifications, for example, synchronous dynamic random access memory (SDRAM), double data rate SDRAM (DDR SDRAM), or even DDRII, DDRIII etc. If it intends to test the memories in different specifications, the structure must be manufactured one by one to cater to various different specifications, which is rather inconvenient.

### SUMMARY OF THE INVENTION

In view of the above problems, the present invention provides a memory-like heat source device, which is suitable for solving the problems or eliminating the defects of the prior art that the structure in the prior art cannot truly simulate the thermal conduction and flow resistance state of the memory, and it cannot be applied to various memory slots in different specifications.

The present invention provides a memory-like heat source device, which is inserted in a slot and received to a power source. The memory-like heat source device includes a substrate, a conductive layer, at least one passive element, a simulative package, an indicator, a Zener diode, and a current limit resistor. The conductive layer is disposed on the substrate, and the passive element, the indicator, the Zener diode, and the current limit resistor are disposed on the conductive layer and electrically connected to the conductive layer. The indicator is used to monitor the operation of the heat source device. The Zener diode and the current limit resistor serve as a protective circuit for the indicator. Upon being powered on, the passive element generates thermal energy, and a simulative package covers the passive element, so as to form a simulative heat source region, thereby simulating the thermal state of a practical memory.

The advantage of the present invention lies in constructing a heat source device applicable for various specifications and having a simulative appearance, so as to truly simulate the thermal conduction and flow-resistance state of the memory.

### BRIEF DESCRIPTION OF THE DRAWINGS

The present invention will become more fully understood from the detailed description given herein below for illustration only, and thus is not limitative of the present invention, and wherein:

FIG. 1 is an exploded view of a memory-like heat source device according to the present invention; and

FIG. 2 is a perspective view of the memory-like heat source device according to the present invention.

### DETAILED DESCRIPTION OF THE INVENTION

In order to make the objective, structure, feature, and function of the present invention more comprehensible, the present invention is described below in detail with the embodiment.

The memory-like heat source device of the present invention is applicable for various memory slots in different specifications, and a simulative heat source device with a simulative appearance and similar thermal conditions may be constructed through simple elements and manufacturing process.

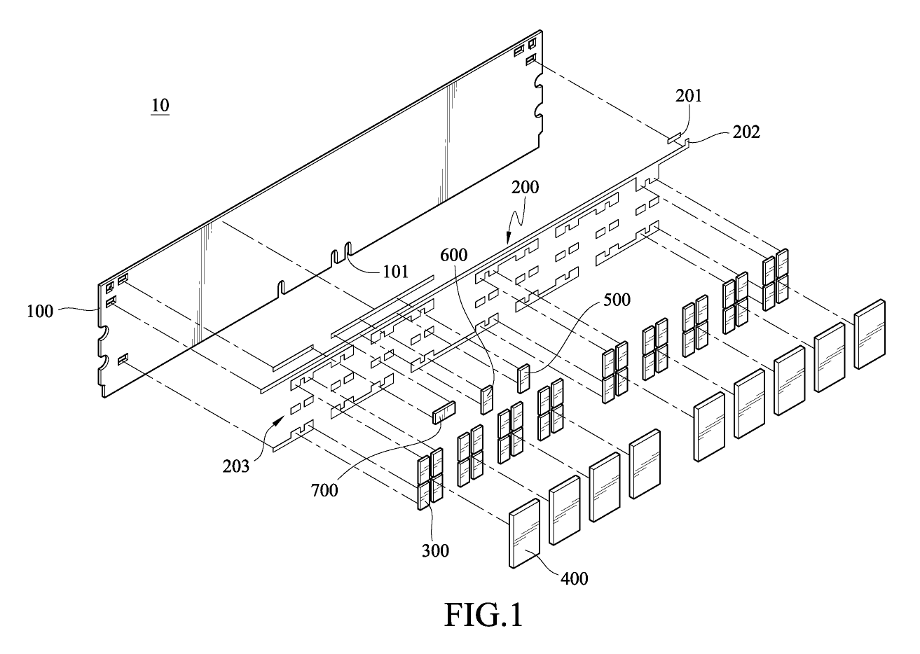

FIG. 1 is an exploded view of a memory-like heat source device according to the present invention. As shown in the FIG. 1, a memory-like heat source device 10 provided by the present invention includes a substrate 100, a conductive layer 200, at least one passive element 300, a simulative package 400, an indicator 500, a Zener diode 600, and a current limit resistor 700.

The substrate 100 has at least one notch 101 matching with various slots in different specifications (not shown).

The conductive layer 200, disposed on the substrate 100, has a pair of electrical contacts 201 and 202, so as to be connected to and received the power, for example, an electric power supplied by a power supplier. The conductive layer 200 has at least one simulative heat source region 203, and the conductive layer 200 is made of copper, aluminum, copper alloy, or aluminum alloy. Those skilled in the art may select different metal materials as the conductive layer 200, which is not limited here.

The passive element 300 is disposed on the simulative heat source region 203 and electrically connected to the conductive layer 200. The passive element 300 receives the power to generate thermal energy, and the passive element 300 is a resistor element (SMD resistor) with a surface mount design (SMD).

The simulative package 400 covers on the passive element 300, and is made of a glass material, but which is not limited to the material provided in this embodiment.

The indicator 500, the Zener diode 600, and the current limit resistor 700 are disposed on the conductive layer 200, and the indicator 500 is disposed on the conductive layer 200 and electrically connected to the conductive layer 200, which is a light emitting diode (LED). The Zener diode 600 and the current limit resistor 700 are both electrically connected to the indicator 500. The Zener diode 600 is used to stabilize a terminal voltage of the indicator 500, and the current limit resistor 700 is used to prevent the indicator 500 from being burnt when the source voltage is too high.

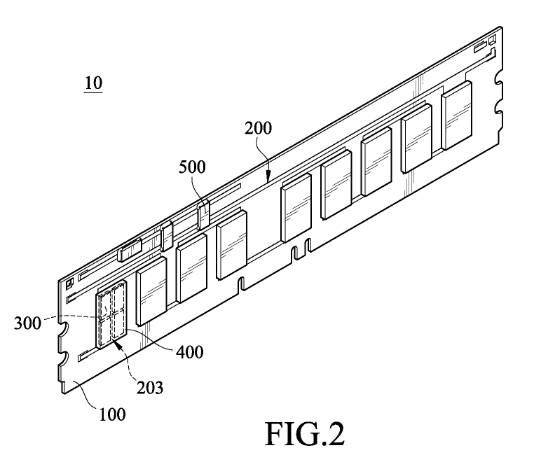

FIG. 2 is a perspective view of a memory-like heat source device according to the present invention. As shown in FIG. 2, in the memory-like heat source device 10 provided by the present invention, the conductive layer 200 is disposed on the substrate 100. The passive element 300 (SMD resistor) is disposed on the conductive layer 200 and electrically connected to the conductive layer 200, so as to receive the power to generate thermal energy. The passive element 300 is further covered with a simulative package 400 made of the glass material, so as to form the plurality of simulative heat source regions 203 having the simulative appearance of the chip after packaging and the thermal conduction features. A gap exists between each two simulative heat source regions 203, and an indicator 500 is disposed to monitor the operation situation of the memory-like heat source device 10 in real time.

What is claimed is:

1. A memory-like heat source device, suitable for being inserted in a slot and received to a power source, comprising:
a substrate;
a conductive layer, disposed on the substrate, having a pair of electrical contacts connected to the power source, and having at least one simulative heat source region;
at least one passive element, disposed on the simulative heat source region, electrically connected to the conductive layer, for receiving the power source to generate thermal energy; and
a simulative package, for covering on the passive element.

2. The memory-like heat source device according to claim 1, further comprising an indicator, disposed on the conductive layer and electrically connected to the conductive layer, wherein the indicator is a light emitting diode (LED).

3. The memory-like heat source device according to claim 2, further comprising a current limit resistor and a Zener diode, electrically connected to the indicator.

4. The memory-like heat source device according to claim 1, wherein the conductive layer is made of copper or aluminum.

5. The memory-like heat source device according to claim 1, wherein the passive element is a resistor element with a surface mount design (SMD).

6. The memory-like heat source device according to claim 1, wherein the simulative package is made of a glass material.

7. The memory-like heat source device according to claim 1, wherein the substrate has at least one notch for matching with the slot.

8. The memory-like heat source device according to claim 1, wherein the conductive layer has a plurality of simulative heat source regions, and there is a gap between each two simulative heat source regions.
